(19) United States
(12) Patent Application Publication
(10) Pub. No.: US 2026/0191135 A1
(43) Pub. Date: Jul. 9, 2026

(54) CONTROLLING A HARVESTER BASED ON SEVERED CROP MATERIAL QUANTITY

(71) Applicant: Deere & Company, Moline, IL (US)

(72) Inventors: Scott N. CLARK, Bettendorf, IA (US); Nathan R. VANDIKE, Geneseo, IL (US)

(21) Appl. No.: 19/013,814

(22) Filed: Jan. 8, 2025

(51) Int. Cl. A01D 41/127; A01D 41/06

(52) U.S. Cl. CPC A01D 41/1271; A01D 41/06

(57) ABSTRACT

Characteristic data indicative of one or more characteristics is obtained at an agricultural harvester. A severed crop material quantity signal indicative of a severed crop material quantity corresponding to a header on the agricultural harvester is generated based on the characteristic data. The severed crop material quantity is assessed to generate an assessment output. The agricultural harvester is controlled at a worksite based on the assessment output.

### FIELD OF THE DESCRIPTION

The present descriptions relate to mobile agricultural machines. More specifically, the present description relates to mobile agricultural harvesting machines configured to harvest at a field.

### BACKGROUND

There are a wide variety of different mobile agricultural machines. One such mobile agricultural machine is a mobile agricultural harvesting machine. The mobile agricultural harvesting machine can include a cutting and gathering platform, sometimes referred to as a header. An agricultural harvesting machines can include various types of headers, such as a row unit header (e.g., corn header), a belt pickup header, a draper header, an auger header, etc. The header can include cutting functionality, such as a cutter bar, that severs crop, forward of the agricultural harvester, just above ground level. The severed crop is then fed by the header toward the center of the harvester where it is moved rearwardly in the harvester to crop processing functionality. The crop processing functionality can include such things as a material handling subsystem cleaning subsystem, residue handling subsystem, etc.

It is not uncommon for agricultural harvesters to use headers that have an effective capacity. The capacity of the header may be defined as the amount of severed material that can be processed by the header and the crop processing functionality of the agricultural harvester over a given time.

The discussion above is merely provided for general background information and is not intended to be used as an aid in determining the scope of the claimed subject matter.

### SUMMARY

Characteristic data indicative of one or more characteristics is obtained at an agricultural harvester. A severed crop material quantity signal indicative of a severed crop material quantity corresponding to a header on the agricultural harvester is generated based on the characteristic data. The severed crop material quantity is assessed to generate an assessment output. The agricultural harvester is controlled at a worksite based on the assessment output.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial pictorial, partial schematic illustration of a harvester.

FIG. 2 is a block diagram showing one example of a harvester control system.

FIG. 3 is a flow diagram showing one example of the operation of a harvester control system.

FIG. 4 is a flow diagram showing one example of analysis used to perform machine learning.

FIG. 5 is a block diagram showing one example of an agricultural system deployed in a remote server environment.

FIG. 6 is a block diagram of one example of a mobile device that can be used in architectures and systems shown in other figures.

FIG. 7 is one example of a mobile device that can be used in architectures and systems shown in other figures.

FIG. 8 shows one example of a mobile device that can be used in architectures and systems shown in other figures.

FIG. 9 is a block diagram showing one example of a computing environment that can be used in architectures and systems shown in other figures.

### DETAILED DESCRIPTION

For the purpose of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, agricultural harvesters often have a header that engages crop, severs the crop, and feeds the crop back into further crop processing functionality in the agricultural harvester. Some headers have a capacity or target which indicates the amount of severed crop material (e.g., volume of the severed crop material) that can (or should) be processed by the header at a given time in an efficient and desired manner. For instance, an agricultural harvester may be traveling at a relatively high speed in which case the amount of severed crop material (e.g., severed crop volume) may exceed the capacity of the header or target that should be processed by the header. In that case, inefficiencies can be encountered, such as plugging, increased crop loss, excessive threshing load (e.g., threshing rotor or cylinder pressure), or other undesirable harvester functionality. Similarly, when the machine is traveling at a relatively low rate of speed, then the amount of severed crop material (e.g., severed crop volume) may be lower than desired target or capacity of the header leading to other inefficiencies. For instance, where the machine is not processing the desired amount of severed crop material, then this can lead to decreased productivity, increased harvest time, increased fuel usage per bushel of harvested material, and/or other undesirable harvesting characteristics.

Thus, the present description describes a system that estimates an amount of severed crop material or severed crop material quantity (e.g., severed crop volume) to be (or being) processed by a harvesting machine. In some examples, the estimated severed crop material quantity (e.g., severed crop volume) can be used by a control signal generator to generate control signals to adjust one or more harvester settings based upon the estimated severed crop material quantity (e.g., severed crop volume). In some examples, the system compares a current severed crop material quantity (e.g., severed crop volume) to a previously estimated severed crop material quantity (e.g., previously estimated severed crop volume) from the operation. The comparison generates a comparison result (e.g., indicative in a change to the amount of severed crop material being processed by the machine) that can be used by a control signal generator to generate control signals to adjust one or more harvester settings based upon the comparison result. In some examples, the system compares the estimated severed crop material quantity (e.g., severed crop volume) to a header capacity value or target value. The comparison generates a comparison result that can be used by a control signal generator to generate control signals to adjust one or more harvester settings based upon the comparison result. In some example, the estimated severed crop material quantity (e.g., severed crop volume), or characteristics indicative thereof, are provided, as input, to a framework (e.g., model, lookup table, etc.) to obtain an output (e.g., control settings, machine settings, etc.) that can be used by a control signal generator to generate control signals to adjust one or more harvester setting based on the output.

While the present description proceeds with respect to a particular harvester that has a particular header and other crop processing functionality, the present description can just as easily apply to other types of harvesters including combine harvesters, forage harvesters, sugar cane harvesters, cotton harvesters, or other agricultural harvesters with any of a wide variety of different headers and crop processing functionality.

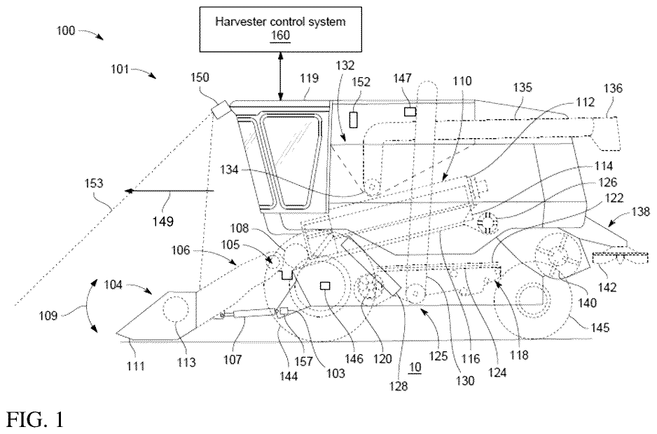

FIG. 1 is partial pictorial, partial schematic illustration of an example agricultural system 100 with agricultural harvester 101. In the example shown in FIG. 1, agricultural harvester 101 is in the form of a combine harvester. As illustrated in FIG. 1, harvester 101 can include, or be coupled to, harvester control system 160. Harvester 101 includes ground engaging traction elements (wheels or tracks) 144 and 145 which can be driven by a propulsion subsystem (e.g., internal combustion engine, electric motors, hydrostatic drive, and other drivetrain elements, such as a gear box) to propel harvester 100 across a worksite (e.g., a field) 10. Harvester 101 includes an operator compartment or cab 119, which can include a variety of different operator interface mechanisms for controlling harvester 101 as well as for presenting (e.g., displaying, etc.) various information. Harvester 101 includes a feeder house 106, a feed accelerator 108, and a thresher or threshing apparatus generally indicated at 110. The feeder house 106 and the feed accelerator 108 form part of a material handling subsystem 125. Header 104 is pivotally coupled to a frame 103 of harvester 101 at pivot axis 105. One or more actuators 107 drive movement of header 104 about axis 105 in the direction generally indicated by arrow 109. Header 104 also has cutting functionality (illustratively a cutter bar) generally indicated by arrow 111. The cutter bar 111 severs crop material so that the crop material can be gathered by header 104 and fed through feeder house 106 for processing by other subsystems on harvester 101. Thus, a vertical position of header 104 and cutter bar 111 (the cutter bar height) above ground 10 over which the header 104 travels is controllable by actuating actuator 107 and may be sensed by cutter bar height sensor (or height sensor) 157. Height sensor 157 may sense the extent to which actuator 107 is actuated. Height sensor 157 may also be mounted on header 104 and include a radar sensor or another type of sensor that senses a distance indicative of the distance that cutter bar 111 is above the worksite 10.

While not shown in FIG. 1, agricultural harvester 101 can also include one or more actuators that operate to apply a tilt angle, a roll angle, or both to the header 104 or portions of header 104.

Agricultural harvester 101 includes a material handling subsystem 125 that includes a threshing apparatus (also referred to as thresher) 110 which illustratively includes one or more threshing components (e.g. rotor(s), cylinder(s), etc.) 112 and a set of concaves or grates 114. Further, material handling subsystem 125 also includes a separator 116. Agricultural harvester 101 also includes a cleaning subsystem or cleaning shoe (collectively referred to as cleaning subsystem 118) that includes cleaning fan(s) 120, chaffer 122, and sieve 124. The material handling subsystem 125 also includes discharge beater 126, tailings elevator 128, and clean grain elevator 130. The clean grain elevator 130 moves clean grain into a material receptacle (or clean grain tank) 132.

Harvester 101 also includes a material transfer subsystem that includes a conveying mechanism 134 and a chute 135. Chute 135 includes a spout 136. In some examples, spout 136 can be movably coupled to chute 135 such that spout 136 can be controllably rotated to change the orientation of spout 136. Conveying mechanism 134 can be a variety of different types of conveying mechanisms, such as an auger, blower, or belted conveyor. Conveying mechanism 134 is in communication with clean grain tank 132 and is driven (e.g., by an actuator, such as a motor or engine) to convey material from grain tank 132 through chute 135 and spout 136. Chute 135 is rotatable through a range of positions from a storage position (shown in FIG. 1) to a variety of deployed positions away from agricultural harvester 101 to align spout 136 relative to a material receptacle of a material receiving machine that is configured to receive the material from within grain tank 132. Spout 136, in some examples, is also rotatable, by an actuator, to adjust the direction of the material stream exiting spout 136.

Harvester 101 also includes a residue subsystem 138 that can include chopper 140 and spreader 142. In some examples, a harvester within the scope of the present disclosure can have more than one of any of the subsystems mentioned above. In some examples, harvester 101 can have left and right cleaning subsystems, separators, etc., which are not shown in FIG. 1.

In operation, harvester 101 illustratively moves through a field 10 in the direction indicated by arrow 149. As harvester 101 moves, header 104 engages the crop plants to be harvested and cutter bar 107 on the header 104 cuts the crop plants to generate severed crop material. The severed crop material is engaged by a cross conveyor (e.g. cross auger, belts, etc.) 113 which conveys the severed crop material to a center of the header 104 where the severed crop material is then moved through an opening to a conveyor in feeder house 106 toward feed accelerator 108, which accelerates the severed crop material into threshing apparatus 110. The severed crop material is threshed by threshing apparatus 110 via threshing component (e.g., rotor, cylinder, etc.) 112 rotating the crop against concaves or grates 114. The threshed crop material is moved through the separator 116 where a portion of the residue is moved by discharge beater 126 toward the residue subsystem 138. The portion of residue transferred to the residue subsystem 138 is chopped by residue chopper 140 and spread on the field by spreader 142. In other configurations, the residue is released from the agricultural harvester 101 in a windrow.

Grain falls to cleaning subsystem 118. Chaffer 122 separates some larger pieces of MOG from the grain, and sieve 124 separates some of finer pieces of MOG from the grain. The grain then falls to a conveyor (e.g., an auger, etc.) that moves the grain to an inlet end of grain elevator 130, and the grain elevator 130 moves the grain upwards, depositing the grain in grain tank 132. Residue is removed from the cleaning subsystem 118 by airflow generated by one or more cleaning fans 120. Cleaning fans 120 direct air along an airflow path upwardly through the sieves and chaffers. The airflow carries residue rearwardly in harvester 101 toward the residue handling subsystem 138.

Tailings elevator 128 returns tailings to threshing apparatus 110 where the tailings are re-threshed. Alternatively, the tailings also can be passed to a separate re-threshing mechanism by a tailings elevator or another transport device where the tailings are re-threshed as well.

Harvester 101 can include a variety of sensors, some of which are illustrated in FIG. 1, such as ground speed sensor 146, one or more mass flow sensors 147, and one or more observation sensor systems (or perception systems) 150, one or more fill level sensors 152, height sensor 157, and any of a variety of other sensors.

Ground speed sensor 146 senses the travel speed of harvester 101 over the ground. Ground speed sensor 146 can sense the travel speed of the harvester 101 by sensing the speed of rotation of the ground engaging traction elements 144 or 145, or both, a drive shaft, an axle, or other components. In some instances, the travel speed can be sensed using a positioning system, such as a global positioning system (GPS), a dead reckoning system, a long-range navigation (LORAN) system, a Doppler speed sensor, or a wide variety of other systems or sensors that provide an indication of travel speed. Ground speed sensors 146 can also include direction sensors such as a compass, a magnetometer, a gravimetric sensor, a gyroscope, GPS derivation, to determine the direction of travel in two or three dimensions in combination with the speed. This way, when harvester 101 is on a slope, the orientation of harvester 101 relative to the slope is known. For example, an orientation of harvester 101 could include ascending, descending or transversely travelling the slope.

Mass flow sensors 147 sense the mass flow of material (e.g., grain) through clean grain elevator 130. Mass flow sensors 147 can be disposed at various locations, such as within or at the outlet of clean grain elevator 130. In some examples, the mass flow rate of material sensed by mass flow sensors 147 is used in the calculation of yield as well as in the calculation of the fill level of the on-board material tank 132. In some examples, mass flow sensors 147 include an impact (or strike) plate that is impacted by material (e.g., grain) conveyed by clean grain elevator 130 and a force or load sensor that detects the force or load of impact of the material on the impact (or strike) plate. This is merely one example of a mass flow sensor.

Observation sensor systems (or perception systems) 150 can include one or more of a variety of sensors, such as cameras (e.g., mono cameras, stereo cameras, color (e.g. RGB) cameras, multispectral cameras, etc.), lidar sensors, radar sensors, ultrasonic sensors, as well as various other sensors configured to emit and/or receive electromagnetic radiation, as well as a variety of other sensors. Systems 150 can also include image processing functionality or other processing functionality that can be used to identify items captured in images or otherwise perceived and that locate the identified items in a global or local coordinate system. Observation sensor systems 150 can illustratively observe (and thus detect characteristics relative to) the worksite 10, items at the worksite 10 (e.g., plants, including crops and weeds at the worksite), and portions of the harvester 101. While FIG. 1 shows some example positions of observation sensor system 150, it will be understood that observation sensor systems 150 can, alternatively or additionally, be positioned (or otherwise disposed) at a variety of other locations on harvester 101. In the example shown in FIG. 1, sensor 150 has a field of view identified by dashed lines 153. The field of view captures plants ahead of header 104 and captures material that is severed by header 104 and that is being processed by header 104. Observation sensor system 150 may be disposed to detect characteristics occurring at or on header 104, biomass amount (e.g. severed crop volume), crop height, grain loss, material other than grain (MOG) intake, stalk diameter, ear size, as well as various other plant characteristics and/or non-plant characteristics.

Fill level sensors 152 can include one or more of a variety of sensors, such as contact sensors and non-contact sensors. Fill level sensors 152 detect a fill level of grain in grain tank 132. Fill level sensors 152, in the form of contact sensors, include paddles (or other contact members) that are contacted by the grain and the displacement of the contact members or force or load of impact of the material on the contact member can be detected to determine presence of grain material at the level of the tank corresponding to the sensor. Fill level sensors 152, in the form of non-contact sensors, can be configured to capture electromagnetic radiation to detect presence of grain at the level of the tank corresponding to the sensor. In some examples, fill level sensors 152 are configured to alert an operator when the harvester 101 is full (or is approaching full). These are merely some examples. While FIG. 1 shows some example positions of fill level sensors 152, it will be understood that fill level sensors 152 can, additionally or alternatively, be positioned (or otherwise disposed) at a variety of other locations on harvester 101, and can include cameras or other sensors.

As discussed above, height sensor 157 can be a sensor that senses the extent to which actuator 107 is actuated, such as a linear position sensor or a Hall Effect sensor. Sensor 157 can be a rotary sensor mounted to sense a rotary position of header 104 about axis 105. Sensor 157 can include a component in contact with the worksite 10 that provides feedback indicative of a position of the cutter bar relative to the worksite 10. Sensor 157 can be a radar sensor, a laser sensor, a global navigation satellite system (GNSS) sensor, or another sensor that senses a variable indicative of an elevation of cutting functionality (e.g., cutter bar) 111 or the distance that cutting functionality (e.g., cutter bar) 111 is located above the ground 10.

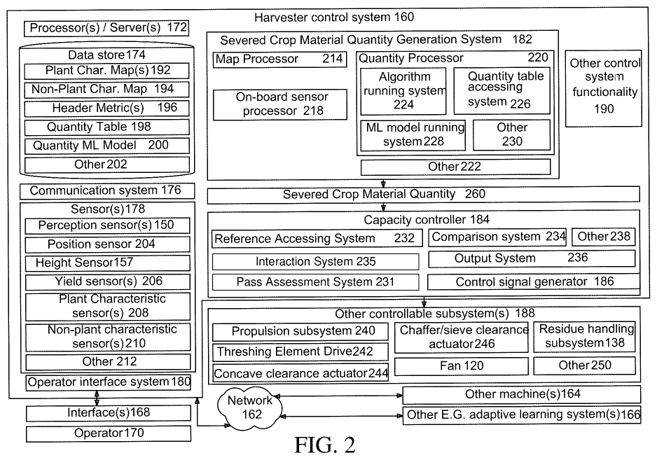

Agricultural harvester 101 can include various other sensors as well, some of which are described below with respect to FIG. 2.

In some examples, the settings on agricultural harvester 101 may be affected or determined based upon the severed crop material quantity (e.g., volume of severed crop) on header 104. Therefore, in one example, agricultural system 100 includes harvester control system 160 that may be in communication with agricultural harvester 101. In one example, harvester control system 160 is located on board agricultural harvester 101. In another example, harvester control system 160, or part of harvester control system 160, is located off-board such as in a remote server environment, on a remote computing system, or elsewhere. In yet another example, harvester control system 160 may be dispersed among a plurality of different locations, such as in a remote server environment, on a remote computing system, and/or onboard agricultural harvester 101.

In one example harvester control system 160 receives inputs, such as from various sensors (e.g., 178, etc.) on agricultural harvester 101 or from maps (e.g., 192, 194, etc.), and generates an output indicative of an estimate of a severed crop material quantity (e.g., severed crop volume) that is to be or is being processed by header 104. Header 104 may have a capacity value that indicates the capacity of the header or a target value that indicates target of a severed crop material quantity (e.g., severed crop volume) that can be handled by header 104 in a desirable fashion, such as with high efficiency. The capacity or target corresponding to header 104 can also indicate the severed crop material quantity (e.g., volume of severed crop material) that can be efficiently processed by the other crop processing systems or subsystems in agricultural harvester 101.

Therefore, in one example, harvester control system 160 generates the output indicative of the severed crop material quantity (e.g., severed crop volume) to be on or on header 104 and compares that severed crop material quantity (e.g., severed crop volume) to a capacity metric or target metric which indicates the capacity or target amount of severed crop material (e.g., severed crop volume) corresponding to header 104. Based upon the comparison result, harvester control system 160 can generate control signals to control machine settings for agricultural harvester 101. In another example, harvester control system 160 generates the output indicative of the severed crop material quantity (e.g., severed crop volume) to be on or on the header 104 and compares that amount of severed crop material (e.g., severed crop volume) to another type of reference metric (e.g., a previous severed crop material quantity estimated during the operation, other threshold metrics, etc.). Based upon the comparison result, harvester control system 160 can generate control signals to control machine settings for harvester 101. In another example, harvester control system 160 generates the output indicative of the amount of severed crop material (e.g., severed crop volume) to be on or on the header 104 and uses the output (e.g., as an input to a model, with a lookup table, etc.) to generate control signals to control machine settings for harvester 101.

The machine settings may include any of a wide variety of different types of machine settings, such as the ground speed of agricultural harvester 101, the threshing component speed, concave or grates clearance, chaffer/sieve clearance, fan speed, residue handling settings, and/or any of a wide variety of other settings.

FIG. 2 is a block diagram showing one example of harvester control system 160 in more detail. In the example shown in FIG. 2, harvester control system 160 is shown in communication over network 162 with one or more other machines 164 and one or more other systems 166 (which may include an adaptive learning system or other systems). In addition, FIG. 2 shows that harvester control system 160 can generate one or more operator interfaces 168 for interaction by an operator 170. Operator 170 may be a human operator, an automated operator, a semi - automated operator, or another operator. Operator 170 thus interacts with interfaces 168 to control and manipulate certain functionality of harvester control system 160 and/or of agricultural harvester 101.

In the example shown in FIG. 2, harvester control system 160 includes one or more processors or servers 172, data store 174, communication system 176, sensors 178, operator interface system 180, severed crop material quantity generation system 182, capacity controller 184, control signal generator 186, other controllable subsystems 188, and any of a wide variety of other control system functionality 190. The data store 174 can include one or more plant characteristic maps 192, one or more non-plant characteristic maps 194, one or more header metrics 196, quantity table 198, quantity machine learning (ML) model 200, and other items 202. Some examples of other items 202 are described below. Sensors 176 can include one or more perception sensors 150, position sensor 204, height sensor 157, one or more yield sensors 206, one or more additional crop characteristics sensors 208, one or more non-crop characteristics sensors 210 and any of a wide variety of other sensors 212.

Severed crop material quantity generation system 182 can include map processor 214 on-board sensor processor 218, severed crop material quantity processor 220, and other items 222. Severed crop material quantity processor 220 can include algorithm running system 224, quantity table accessing system 226, ML model running system 228, and other items 230. Capacity controller 184 can include pass assessment system 231, reference accessing system 232, comparison system 234, interaction system 235, output system 236, and other items 238. Other controllable subsystems 188 can include a propulsion subsystem 240, a threshing component drive subsystem 242, a concave or grates clearance actuator 244, a chaffer/sieve clearance actuator 246, one or more fans 120, residue handling subsystem 138, and any of a wide variety of other controllable subsystems 250. Before describing the overall operation of harvester control system 160 in more detail, a description of some of the items in harvester control system 160, and their operation, will first be provided.

A plant characteristic map 192 illustratively includes a geo-referenced set of plant characteristic values such as, but not limited to, crop health values, crop height values, crop state values, crop moisture values, crop type values, crop yield values, crop brittleness values, crop stalk size values, crop head/ear/pod size values, weed presence values, weed intensity values, weed type values, as well as values of various other plant characteristics. The geo-referenced plant characteristic values are values that map the plant characteristic (measured or estimated (e.g., predicted)) across the worksite 10 over which harvester 101 is traveling. A non-plant characteristic map 194 illustratively includes a geo-referenced set of non-plant characteristic values, such as, but not limited to, topographic values, soil moisture values, as well as values of various other non-plant characteristics. The geo-referenced non-plant characteristic values are values that map the non-plant characteristic values (measured or estimated (e.g., predicted)) across the worksite 10 over which harvester 101 is traveling. In some examples, maps 192 and 194 are generated prior to the operation of harvester 101 at the worksite 10 during a current season, such as generated based on data collected in operations (e.g., planting, material application (e.g., spraying), tilling, etc.) prior to the harvesting operation, generated based on data collected during scouting operations at the worksite 10 prior to the harvesting operation, or generated based on data collected from aerial (e.g., satellite, fly-over (e.g., drone), etc.) surveys of the worksite 10 conducted prior to the harvesting operation.

Header metrics 196 may be one or more metric values, such as metric values indicative of the capacity of the header or of a target amount of biomass (e.g., severed crop volume) corresponding to header 104. Header metrics may also be capacity or target severed crop material quantity values corresponding to a plurality of different headers that are indexed by a header identifier (which may be a header model number or another identifier). Header metrics 196 illustratively identify the severed crop material quantity (e.g., severed crop volume) capacity or target corresponding to header 104 for different crops, under different crop conditions, or according to other criteria. In one example, the header metrics 196 may be default values, values entered by an operator, values calculated dynamically based upon plant characteristics, non-plant characteristics, environmental characteristics (e.g., weather characteristics, etc.), or other criteria. Quantity table 198 may be a table of severed crop material quantity (e.g., severed crop volume) values that are indexed by various criteria. For instance, the severed crop material quantity (e.g., severed crop volume) values in quantity table 198 may be indexed by crop type, by environmental characteristics or plant characteristics, by non-plant characteristics, or other criteria.

Quantity ML model 200 may be a machine learning model that is trained to receive, as an input, various model parameters or model input values (e.g. values detected by sensors 178 or obtained (or derived) from map(s) 192 and/or 194, or both). Biomass ML model 200 then generates an output indicative of an estimate of the severed crop material quantity (e.g. severed crop volume) to be on or on header 104. For instance, the quantity ML model 200 may be a machine learning model that takes, as an input, the outputs from one or more different sensors (e.g., 178) that are processed by severed crop material quantity generation system 182. Based upon those sensor values, the quantity ML model 200 may generate an output indicative of the severed crop material quantity (e.g., severed crop volume) to be on or on header 104. In another example, the quantity ML model 200 may be a machine learning model that takes, as an input, the data from one or more maps (e.g., 192 or 194, or both) that are processed by severed crop material quantity generation system 182. Based upon those map values, the quantity ML model 200 may generate an output indicative of the severed crop material quantity (e.g., severed crop volume) to be on or on the header 104. In some examples, the ML model 200 may take, as input, both sensor values and map values and generate an output indicative of the severed crop material quantity (e.g., severed crop volume) to be on or on header 104.

Communication system 176 illustratively facilitates communication of the items in harvester control system 160 with one another, and also with other machines 164 and/or other systems 166 over network 162. Therefore, communication system 176 may be a controller area network (CAN) bus and bus controller, a cellular communication system, a near field communication system, a wide area network or local area network communication system, a Wi-Fi or Bluetooth system, and/or a wide variety of other communication systems or combinations of systems.

Different examples of perception systems (or perception sensors) 150 and cutter bar height sensor 157 were described above. Position sensor 204 may be a sensor that generates an output indicative of the location of position sensor 204 in a global or local coordinate system. Therefore, position sensor 204 may be a global navigation and satellite system (GNSS) system, a cellular triangulation system, a dead reckoning system, or any of a wide variety of other position sensors or position sensing systems. Yield sensor 206 may be a mass flow sensor, an optical sensor, a pressure sensor that senses the pressure used to drive one or more threshing components 112, or any of a variety of the sensors described above with respect to FIG. 1 (such as mass flow sensors 147, fill level sensors 152, height sensors, scales, and/or other measurement systems that measure or generate an output indicative of the yield of crop material being processed by agricultural harvester 101).

Plant characteristic sensors 208 may sense any of a wide variety of different plant characteristics. Such sensors may sense crop health, crop height, crop state, crop moisture, material other than grain (MOG) moisture, crop type, crop brittleness, crop stalk size, crop head/ear/pod size, weed presence, weed intensity, weed type, as well as any of a wide variety of other plant characteristics. In some examples, plant characteristic sensors 208 can include a wide variety of different types of sensors including, but not limited to, perception sensors (e.g., 150). Non-crop characteristics sensors 210 can sense non-crop characteristics, such as environmental characteristics (e.g., weather characteristics), machine characteristics (e.g., machine settings, machine performance, etc.) or other characteristics. One example of a non-plant characteristic is a material flow of severed material on the header 104. Non-crop characteristic sensors 210 can include a wide variety of different types of sensors including, but not limited to, perception sensors (e.g., 150).

Operator interface system 180 can include operator interface mechanisms that generate interfaces 168 for output of information to operator 170. The operator interface mechanisms can also receive inputs from operator 170. Therefore, the interface mechanisms can include joysticks, a steering wheel, brake levers, pedals, buttons, switches, display screens, microphones, loudspeakers, lights, and other mechanisms. The display screen may be a touch sensitive display screen, or another display screen. The display screen may display operator in input mechanisms such as icons, buttons, links, etc. Those mechanisms can be actuated by operator 170 using touch gestures, voice commands, point-and-click devices, or in other ways. The operator interface system 180 may include other mechanisms for generating audio, visual, and/or haptic outputs to operator 170 and/or for receiving inputs from operator 170.

Severed crop material quantity generation system 102 can receive inputs from data store 104 and one or more sensors 178 and/or other sources and generate a severed crop material quantity (e.g., severed crop volume) metric value 260. Severed crop material quantity (e.g., severed crop volume) metric value 260 can be provided to capacity controller 184 where metric value 260 can be used (e.g., by control signal generator 186) to generate control signals to control systems or settings on harvester 101 or other controllable subsystems 188 based upon the severed crop material quantity (e.g., severed crop volume) metric value 260. In one example, controller 184 can compare metric value 260 against a header metric 196 which indicates the severed crop material quantity (e.g., severed crop volume) capacity or target corresponding to header 104. Capacity controller 184 can generate an output indicative of that comparison to control signal generator 186, which can be used by control signal generator 186 for the generation of control signals. In one example, controller 184 can compare the metric value 260 against another reference metric (e.g., a previously generated metric value 260) and can generate an output indicative of that comparison to control signal generator 186, which can be used by control signal generator 186 for the generation of control signals. In one example, controller 184 can interact with a control framework (e.g., model, lookup table, etc.) based on the metric value 260 and can generate an output, based on the interaction, that can be used by control signal generator for the generation of control signals.

Severed crop material quantity generation system 182 can use on-board sensor processor 218 to obtain and process inputs from one or more sensors 178 that may be indicative of the severed crop material quantity (e.g., severed crop material volume) to be or being processed by header 104. On-board sensor processor 218 can receive inputs from sensors 178 (such as from perception sensor 150, cutter bar height sensor 157, yield sensors 206, other characteristics sensors 208 and 210) and generate an output indicative of these sensor signals or derived from the sensor signals. As an example, but not by limitation, on-board sensor processor 218 can also receive a sensor signal from perception sensor 150 to determine the height of the crop that has been or is being severed. Based on the height of the crop and the height at which the crop is severed, on-board sensor processor 218 can identify the height of the severed crop that is being processed by header 104 and, thus, a severed crop material quantity (e.g., severed crop material volume) can be identified. In one example, sensor signals from perception sensors 150 can be used to determine the height of the crop prior to the crop being severed and the height of the remaining stubble after the crop is severed by on-board sensor processor 218 to identify a height of the severed crop that is being or is to be processed by header 104 and, based thereon, a corresponding severed crop material quantity (e.g., severed crop material volume) can be identified.

Severed crop material quantity generation system 182 can use map processor 214 to access and process one or more maps (e.g., 192 or 194, or both) that may include values indicative of the severed crop material quantity (e.g., severed crop material volume) to be or being processed by header 104. Map processor 214 can obtain, or derive, values from the maps and generate an output indicative of the map values or derived from the map values. As an example, but not by limitation, map processor 214 can obtain yield values from a map (e.g., 192). Based, at least, on yield values for a crop to be or is being processed by the harvesting machine 101, quantity processor 220 can identify a severed crop material quantity (e.g., severed crop material volume) that is to be or is being processed by header 104. As another example, map processor 214 can obtain topographic values from a map (e.g., 194). Based, at least, on topographic values corresponding to a crop to be or that is being processed by the harvesting machine 101 (i.e., topographic values corresponding to the ground from which the crop was/is to be taken), quantity processor 220 can identify a severed crop material quantity (e.g., severed crop material volume) that is to be or is being processed by header 104.

Quantity processor 220 can receive inputs from the various processors 214 and 218, as well as inputs from data store 174 and one or more sensors 178, and based upon those inputs, generates the severed crop material quantity (e.g., severed crop volume) metric value 260 that is indicative of the amount of severed crop material (e.g., volume of severed crop material) that is to be or is being processed by header 104. Quantity processor 220 can do this in a variety of different ways. For instance, algorithm running system 224 can run an algorithm in response to the outputs from the different processors 214 and 218, as well as in response to other information. Algorithm running system 224 can run an algorithm that estimates or generates an output of severed crop material quantity (e.g., severed crop volume) metric value 260 based upon those inputs. The algorithm can be accessed from data store 174. The algorithm can be a rules-based algorithm or other heuristic.

In another example, quantity table accessing system 226 receives the various inputs and, based upon those inputs, accesses quantity table 198 in data store 174. The quantity table 198 illustratively has a plurality of different severed crop material quantity (e.g., severed crop volume) metric values 260 indexed based upon criteria that are indicated by the various inputs to quantity table accessing system 226. For instance, given a particular value for each one of a plurality of different plant characteristics (e.g., sensed or derived from a map) or for each one of a plurality of different non-plant characteristics (e.g., sensed or derived from a map), or both, and any other of a variety of inputs, quantity table accessing system 226 can access biomass table 198 using those inputs to look up a value for a severed crop material quantity (e.g., severed crop volume) metric 260. Thus, in one example, quantity table 198 is a look up table. The quantity table accessing system 226 can access a quantity table in other ways as well.

In another example, ML model running system 228 accesses a machine learning model 200 and provides, as inputs to model 200, the various inputs received from the different processors 214 and 218, as well as any other criteria that may be received. Using that information as model inputs to quantity ML model 200, model running system 228 can run the model to generate an output indicative of the value of the severed crop material quantity (e.g., severed crop volume) metric 260. It will be noted that quantity ML model 200 may be a generative artificial intelligence (AI) model, a deep learning model, an artificial neural network, or another model. The model may be adapted using an adaptive learning system which may be stored on other systems 166 or in other locations. Therefore, machine learning can be used to continuously or intermittently adapt or modify the quantity ML model 200 to improve the accuracy of the quantity ML model 200.

Using one of these mechanisms, or another mechanism, severed crop material quantity generation system 182 outputs the severed crop material quantity (e.g., severed crop volume) metric value 260 to capacity controller 184.

Reference accessing system 232 identifies a reference value, such as a previously identified metric value 260 (e.g., from earlier in the harvesting operation) or a capacity or target value corresponding to header 104. In one example, reference accessing system can access or look up the previously identified metric value 260 from data store 174 by accessing other data 202 where previously identified metric values 260 can be stored. In one example, accessing system 232 can access or look up the capacity value or target value from data store 174 by accessing the header metrics 196. Reference accessing system 234 may receive an input identifying the particular header 104 that is being used on agricultural harvester 101 and use the identity of header 104 to look up the header metric 196 for that particular header. In another example, header capacity accessing system 232 can use a default capacity value or default target value or a capacity value or a target value that is input by operator 170 or that is received or accessed over communication system 176 or in other ways.

In one example, comparison system 234 then compares the severed crop material quantity (e.g., severed crop volume) metric value 260 to the header capacity or target value output by reference accessing system 232. Based on that comparison, output system 236 generates an output (e.g., comparison result) indicating whether the severed crop material quantity (e.g., severed crop volume) to be or being processed by header 104 meets, exceeds, or is below the capacity or target value output by reference accessing system 232. That output (e.g., comparison result) is then provided to control signal generator 186 which generates control signals based upon the output (e.g., comparison result).

In one example, comparison system 234 compares the severed crop material quantity (e.g., severed crop volume) metric value 260 to a previous severed crop material quantity (e.g., severed crop volume) metric value 260 (such as the most recent previous severed crop material quantity (e.g., severed crop volume) metric value 260) generated earlier in the operation and output by reference accessing system 232. Previous severed crop material quantity (e.g. severed crop volume) metric values 260 can be stored in data store (e.g., as other data 202). Based on the comparison, output system 236 generates an output (e.g., comparison result) indicative of a change in the severed crop material quantity (e.g., severed crop volume) being or to be processed by the harvesting machine 101 (e.g., change from previous amount processed by the harvesting machine 101). That output (e.g., comparison result) is then provided to control signal generator 186 which generates control signals based on the output (e.g., comparison result).

In another example, interaction system 235 may interact with a control or machine setting framework (e.g., model, lookup table, mapping, etc.) by providing metric value 260, as input to the framework. Based upon the interaction with the control or machine setting framework, output system 236 generates an output (e.g., control value(s) or machine setting value(s) output by the framework in response to input metric value 260). That output (e.g., control value(s) or machine setting value(s)) is then provided to control signal generator 186 which generates control signals based on the output (e.g., control value or machine setting value). The control or machine setting framework can be stored in data store 174 as other data 202 and can be accessed by interaction system 235.

In one example, output system 236 can determine whether a response is required or whether an assessment (e.g., by interaction system 235 or comparison system 234) is needed. For instance, pass assessment system 231 can determine whether the harvesting machine 100 is harvesting a full pass or less than a full pass. In some cases, the harvesting machine 100 may be harvesting less than a full pass (e.g. only engaging crop across a portion of the cutting width of header 104 rather than engaging crops across the entire cutting width of header 104 as would be the case in a full pass). When cutting less than a full pass, it may not be necessary to adjust control or to perform an assessment. Or a severed crop material quantity being less than a reference value (e.g., header capacity, target, historical quantity) may not require response (e.g., adjusted control) as it may be expected that the quantity will be less where harvesting less than a full pass and subsequent control adjustment may not be required. Thus, pass assessment system 231 can generate an output indicative of whether the harvesting machine is harvesting a full pass or less than a full pass and based thereon, output system 236 can determine whether a response is required or whether an assessment (e.g., by interaction system 235 or comparison system 234) is needed in correspondence with a generated severed crop material quantity 260. It will be understood that even where it is determined that neither a response nor an assessment is needed for a given severed crop material quantity 260, said severed crop material quantity 260 can still be utilized in other ways, such as, for example, by adaptive learning systems 166.

The control signals generated by control signal generator 186 can be used to control communication system 176, operator interface system 180, and/or any of a variety of the other controllable subsystems 188. Propulsion subsystem 240 may be an internal combustion engine, an electric motor, or another power source that is coupled to the ground engaging elements (e.g., wheels or tracks) through a transmission in order to propel agricultural harvester 101. Threshing component drive subsystem 242 may drive threshing component(s) 112 in agricultural harvester 101. Thus, threshing component drive subsystem 242 can include a motor or pump, or another drive mechanism, that is used to drive (e.g., rotate, etc.) the threshing component(s) 112.

Concave or grates clearance actuator 244 may be an actuator that changes the clearance of concaves or grates 114 on agricultural harvester 101. Therefore, concave or grates clearance actuator 244 may be an electrical actuator, a hydraulic actuator, a pneumatic actuator, or any of a wide variety of other actuators. Chaffer/sieve clearance actuator 246 is an actuator that changes the chaffer and/or sieve clearance on agricultural harvester 101. Thus, actuator 246 may be a hydraulic actuator, an electric actuator, a pneumatic actuator, and/or any of a wide variety of other actuators. One example of fan 120 and residue handling subsystem 138 has been described above with respect to FIG. 1.

In one example, when the output provided by output system 236 indicates that the severed crop material quantity (e.g., severed crop volume) to be or being processed by header 104 is below the capacity value or target value or is below a previously severed crop material quantity (e.g., previously identified severed crop volume), then the control signal generator 186 may generate a control signal to control propulsion subsystem 240 to increase the ground speed of agricultural harvester 101 in order to increase the severed crop material quantity (e.g., severed crop volume) by increasing the quantity rate (e.g., volumetric flow rate) of severed crop material. When the output provided by output system 236 indicates that the severed crop material quantity (e.g., severed crop volume) is above the capacity value or target value of header 104 or above a previously identified severed crop material quantity (e.g., previously identified severed crop volume), then control signal generator 186 may generate a control signal to control propulsion subsystem 240 to slow down the ground speed of agricultural harvester 101. In yet other examples, the output provided by output system 236 may indicate a control value or machine setting value (e.g., via interaction provided by interaction system 235) indicating a ground speed of agricultural harvester 101 based upon which control signal generator 186 may generate a control signal to control propulsion subsystem 240 to adjust the ground speed of the agricultural harvester (in correspondence with the output control value or machine setting value).

In one example, based upon whether (as indicated by an output provided by output system 236) the severed crop material quantity (e.g., severed crop volume) exceeds the reference (e.g., capacity value, target value, or previously identified biomass amount value) or is below the reference (e.g., capacity value, target value, or previously identified biomass amount value), control signal generator 186 may generate control signals to control threshing component drive subsystem 242, concave clearance actuator 244, chaffer/sieve clearance actuator 246, fan 120, residue handling subsystem 138, and/or any of a wide variety of other subsystems. In yet other examples, the output provided by output system 236 may indicate control value(s) or machine setting value(s) (e.g., via interaction provided by interaction system 235) indicating a setting value for each of one or more of the threshing component subsystem 242, concave clearance actuator 244, chaffer/sieve clearance actuator 246, fan 120, residue handling subsystem 238, and/or any of a wide variety of other subsystems based upon which control signal generator may generate control signals to control threshing component subsystem 242, concave clearance actuator 244, chaffer/sieve clearance actuator 246, fan 120, residue handling subsystem 238, and/or any of a wide variety of other subsystems.

Further, control signal generator 186 can generate a control signal to communicate the output provided by output system 236 or other information based on the output to other machines 164 or other systems 166 over network 162 using communication system 176. Control signal generator 186 can also generate control signals to control operator interface system 182 to display alerts or other information to operator 170 based upon the output provided by output system 236. In addition, control signal generator 186 may output the severed crop material quantity (e.g., severed crop volume) metric value 260 to operator 170 using operator interface system 180, or to other machines 164 and other systems 166 using communication system 176. Control signal generator 186 can generate control signals in other ways as well.

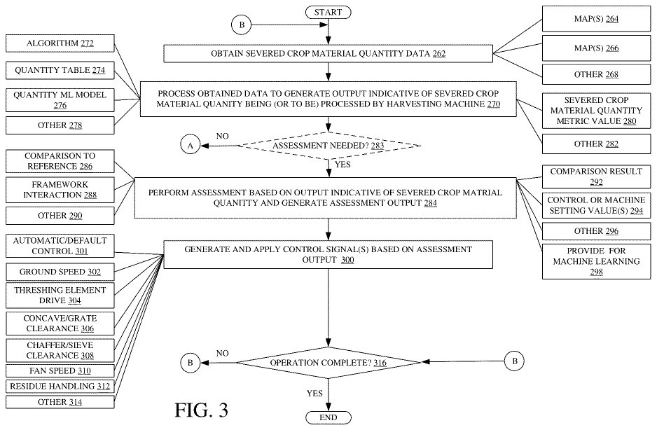

FIG. 3 is a flow diagram illustrating one example of the operation of harvester control system 160. Severed crop material quantity generation system 182 obtains data indicative of severed crop material quantity (e.g., severed crop material quantity data) of crop to be or being processed by the harvesting machine 101. Obtaining the severed crop material quantity data is indicated by block 262 in the flow diagram of FIG. 3. In one example, the severed crop material quantity data may be obtained, or derived, from one or more plant characteristic maps 192 or one or more non-plant characteristic maps 194, or both. Obtaining, or deriving, the severed crop material quantity data based on one or more maps (e.g., 192 or 194, or both) is indicated by block 264 in the flow diagram of FIG. 3. In another example, the severed crop material quantity data may be obtained, or derived, from sensor data generated by one or more sensors 178. Obtaining, or deriving, the severed crop material quantity data based on sensor data from one or more sensors (e.g., 178) is indicated by block 266 in the flow diagram of FIG. 3. In other examples, as indicated by block 268, the severed crop material quantity data can be obtained, or derived, in other ways, including from other sources or obtaining, or deriving, from a combination of maps (e.g., 192 or 194, or both) and sensor data from sensor (e.g., 178).

The obtained severed crop material quantity data is processed by severed crop material quantity generation system 182 to generate an output (e.g., 260) indicative of the severed crop material quantity to be or being processed by the harvesting machine 101. Processing the obtained data and generating the output is indicated by block 270. Processing the obtained data to generate the output can include various forms of processing. In one example, as indicated by block 272, algorithm running system 224 runs a quantity estimation algorithm based upon the obtained data to generate the output. In another example, as indicated by block 274, quantity table accessing system 226 accesses quantity table 198 to generate the output based upon the obtained data. In another example, as indicated by block 276, ML model running system 228 runs a quantity ML model 200 to generate the output based upon the obtained data. The output indicative of severed crop material quantity can be obtained in other ways as well, as indicated by block 278.

The output indicative of severed crop material quantity to be or being processed by the harvesting machine can be a severed crop material quantity metric value 260 as indicated by block 280. In other examples, as indicated by block 282, the output can in various other forms or can include, in addition to metric value 260, various other information.

The output (e.g., severed crop material quantity metric value 260) is then provided to capacity controller 184. In some examples, as indicated by block 283, capacity controller 184 (e.g., pass assessment system 231) determines whether a quantity assessment and/or a response is needed based on the output (e.g., severed crop material quantity metric value 260). For instance, an assessment and/or response may or may not be needed depending on whether the harvesting machine 100 is harvesting a full pass or less than a full pass. In such examples, if it is determined that an assessment and/or response is not needed, then processing proceeds to block 316. In such examples, if it is determined that an assessment and/or response is needed, then processing proceeds to block 284. Of course, in some examples, it need not be determined whether an assessment and/or response is needed and thus, the processing at block 283 need not be performed, in which case, processing proceeds from block 270 to block 284.

Capacity controller 184 performs a quantity assessment based on the output and generates an assessment output based on the quantity assessment. Capacity controller 184 obtaining the output indicative of the severed crop material quantity, performing a quantity assessment, and generating the quantity output is indicated by block 284.

In one example, as indicated by block 286, reference accessing system 232 obtains a reference (e.g., reference metric value) and comparison system 234 compares the reference to the obtained output (e.g., metric value 260). The reference, in one example, can be a capacity value or target value corresponding to the harvesting machine 101 (e.g., header 104), such as a header metric 196 or a capacity value or target value provided in other ways (e.g., default value, provided by operator, etc.). The reference, in another example, can be a previously identified output (e.g., previously identified severed crop material quantity metric value 260) generated earlier in the harvesting operation. In one example, as indicated by block 292, output system 236 generates, as the assessment output, a comparison result based on the comparison between the obtained output and the reference.

In another example, as indicated by block 288, interaction system 235 interacts with a control or machine setting framework (e.g., model, lookup table, mapping, etc.) based upon the obtained output (e.g. metric value 260), such as by providing the obtained output (e.g., metric value 260), as input, to the framework. Based upon the interaction with the framework, output system 236 generates, as the assessment output, control value(s) or machine setting value(s) identified by the framework in correspondence to the obtained output (e.g., metric value 260). Generating the assessment output as control value(s) or machine setting value(s) is indicated by block 294. The assessment output can be obtained in other ways as well, as indicated by block 296. Further, it will be noted that capacity controller 194 (e.g., output system 236) Comparison result output system 236 can then provide the output to different functionality in order to perform different processes. For instance, in one example, output system 236 uses communication system 176 to provide the output to an adaptive learning system (which may be found on other systems 166 or elsewhere) for machine learning to adapt the quantity ML model 200. Providing the output for machine learning is indicated by block 292 in the flow diagram of FIG. 3.

Based upon the assessment output, control signal generator 186 generates and applies control signals to adjust machine settings or machine performance as indicated by block 300 in the flow diagram of FIG. 3. For instance, the assessment output can be output to operator 170 so that operator 170 can perform manual adjustment of the machine settings. In another example, control signal generator 186 can generate control signals to perform automated adjustment of the machine operation, and in yet another example, control signal generator 186 can generate an output signal indicative of default values for machine settings. Generating automatic control signals, default control signals, or manual control outputs is indicated by block 300 in the flow diagram of FIG. 3.

Control signal generator 186 can generate and apply control signals to control one or more controllable subsystems 188 based on the assessment output. For example, control signal generator 186 generates and applies control signals to control propulsion subsystem 240 in order to adjust the ground speed of agricultural harvester 101, as indicated by block 302. Additionally, or alternatively, the control signals can be output and applied to control threshing component drive 242, such as to increase drive force or to adjust threshing component speed, as indicated by block 304. Additionally, or alternatively, the control signals can be output and applied to control concave/grate clearance actuator 244 to adjust concave/grate clearance, as indicated by block 306. Additionally, or alternatively, the control signals can be output and applied to chaffer/sieve clearance actuator 246 to adjust chaffer/sieve clearance, as indicated by block 308. Alternatively, or additionally, the control signals can be output and applied to fan 120 to control fan speed, as indicated by block 310. Additionally, or alternatively, the control signals can be output to residue handling subsystem 138 to control residue handling as indicated by block 312. A wide variety of other control signals can be output and applied to perform other machine settings control or machine operation control as indicated by block 314. Until the operation is complete, as indicated by block 316, operation reverts to block 262.

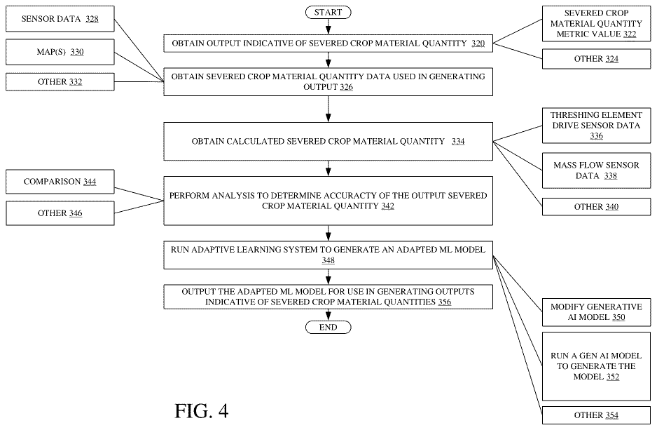

FIG. 4 is a flow diagram illustrating one example of performing adaptive learning to improve the accuracy of the quantity ML model 200 in generating an output indicative of severed crop material quantity on or to be on machine 101 (e.g., header 104). For example, the adaptive learning may receive the severed crop material quantity estimates generated by model 200 based upon various inputs and compare that severed crop material quantity estimate to severed crop material quantity calculated based on signals that represent actual, measured values that are measured during subsequent processing of the severed crop material in agricultural harvester 101. The estimated severed crop material quantity metric value 260 output by model 200 can then be compared to the calculated severed crop material, that is based upon actual measurements, in order to identify the accuracy of the severed crop material quantity metric value 260 output by model 200. Based upon that accuracy, model 200 can be adapted or changed through machine learning to improve its accuracy.

Adaptive learning system 166 obtains an output indicative of a severed crop material quantity corresponding to a crop engaged by the harvester 101. Obtaining the output is indicated by block 320. In one example, the output is a severed crop material quantity metric value 260, as indicated by block 322, though, in other examples, the output can be in a different form or can include information in addition to the metric value 260, as indicated by block 324. At block 326, adaptive learning system 166 obtains severed crop material quantity data (or values derived therefrom) that corresponds to the obtained output (e.g., the severed crop material quantity data, or values derived therefrom, used in generating the obtained output). In one example, as indicated by block 328, the severed crop material quantity data can be sensor data generated by sensors (e.g., 178) or can be values derived from such sensor data. In one example, as indicated by block 330, the severed crop material quantity data can be map data (e.g., map(s) 192 or 194, or both) or values derived from such map data. In one example, as indicated by block 332, the severed crop material quantity data, or values derived therefrom, can be in other forms or can be a combination of sensor data (or values derived therefrom) or map data (or values derived therefrom).

At block 334, adaptive learning system 166 obtains a calculated severed crop material quantity (e.g., a calculated severed crop material metric value). As previously discussed, the calculated severed crop material quantity can be calculated based on signals (e.g., sensor data) that represent actual, measured values that are measured during subsequent processing of the severed crop material corresponding to the output (e.g., metric value 260). The adaptive learning system 166 may access the signals (e.g., sensor data) and calculate the calculated severed crop material quantity based thereon. The signals (e.g., sensor data) can include threshing component drive sensor data generated by sensors 178, as indicated by block 336. The signals (e.g., sensor data) can include mass flow sensor data generated by sensors 178, as indicated by block 336. In other examples, as indicated by block 340, the signals may include other types of data, including other types of sensor data, or a combination of threshing component drive sensor data and mass flow sensor data. Threshing component drive sensor data indicates a force (e.g., pressure, torque, etc.) used to drive threshing components and may be correlated to severed crop material quantity. Therefore, based on the latency introduced by movement of crop from the header 104 to the threshing components 112, the threshing component drive sensor data may be correlated to the severed crop material quantity estimate 260 and may be used to calculate a calculated severed crop material quantity. Mass flow sensor data indicates a mass flow of crop material moving through agricultural harvester and may be correlated to severed crop material quantity. Again, based upon the latency introduced by movement of the crop material through agricultural harvester 101, the mass flow sensor data can be correlated to the estimated severed crop material quantity 260 and may be used to calculate a calculated severed crop material quantity. Other types of data, including other types of sensor data, or a combination of threshing component drive sensor data and mass flow sensor data may be correlated to the estimated severed crop material quantity estimate 260 and may be used to calculate a calculated severed crop material quantity.

The adaptive learning system 166 performs analysis to determine the accuracy of the obtained output (e.g., severed crop material quantity metric value 260) based on the obtained output and the calculated severed crop material quantity. Performing analysis to determine the accuracy of the obtained output (e.g., severed crop material quantity metric value 260) is indicated by block 342 in the flow diagram of FIG. 4. In one example, the adaptive learning system 166 compares the obtained output (e.g., severed crop material quantity metric value 260) to the calculated severed crop material quantity (e.g., calculated severed crop material quantity metric value) or indicator generated from the obtained signals (e.g., threshing component drive sensor data, mass flow sensor data, other signals or combination), in order to determine the accuracy of the obtained output (e.g., severed crop material quantity metric value 260). Such a comparison is indicated by block 344 in the flow diagram of FIG. 4. The accuracy of the obtained output (e.g., severed crop material quantity metric value 260) can be determined based upon the calculated severed crop material quantity or indicator generated from the obtained signals (e.g., threshing component drive sensor data, mass flow sensor data, other signals or combination), or in other ways as well, as indicated by block 346.

Adaptive learning system 166 then runs adaptive learning (e.g., an adaptive learning system or algorithm) to generate an adapted quantity ML model 200. The adaptive learning can utilize the obtained output (e.g., severed crop material quantity metric value 260), the calculated severed crop material quantity (or indicator from obtained signals, and the obtained severed crop material quantity data used in generating the output. In some examples, the adaptive learning utilizes the analysis or analysis result from block 342 (e.g., comparison result from block 344 or other analysis result from block 346) along with the obtained severed crop material quantity data used in generating the output. For example, the data can be used to adjust model values (e.g. weights and biases) used (applied to input severed crop material quantity data) in generating estimated crop material quantities (e.g., metric values 260). Thus, the calculated severed crop material quantity or the difference or error between the estimated severed crop material quantity and the calculated severed crop material quantity can be used to affect model convergence. Running the adaptive learning is indicated by block 348 in the flow diagram of FIG. 4. In one example, the quantity ML model 200 is a generative artificial intelligence (AI) model and the output of the adaptive learning system 166 is a modified generative AI model that is used as the quantity ML model 200. Modifying or training a generative AI model is indicated by block 350 in the flow diagram of FIG. 4.

In another example, the adaptive learning system 166, itself, is a generative AI model that is run to generate an adapted quantity ML model 200. Running a generative AI model to modify the quantity ML model 200 is indicated by block 352 in the flow diagram of FIG. 4. The adaptive learning system 166 can be run in other ways as well to generate an adapted quantity ML model 200, as indicated by block 354 in the flow diagram of FIG. 4.

Adaptive learning system 166 then outputs the adapted quantity ML model for use in generating additional (e.g. subsequent, such as subsequent during the harvesting operation) outputs indicative of severed crop material quantities (e.g., additional severed crop material quantity metric values 260) as indicated by block 356 in the flow diagram of FIG. 4.

It can thus be seen that the present description describes a system that generates an output indicative of severed crop material quantity (e.g., severed crop material volume) to be or being engaged by header 104 on agricultural harvester 101. That severed crop material quantity can be compared against a reference (e.g., target value, capacity value, previously determined severed crop material quantity, etc.) or used in interaction with a control framework to generate an output. Based upon the output, control signals are generated to control the operation of the agricultural harvester 101 accordingly.

The present discussion has mentioned processors and servers. In one example, the processors and servers include computer processors with associated memory and timing circuitry, not separately shown. The processors or servers are functional parts of the systems or devices to which they belong and are activated by, and facilitate the functionality of, the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing the data stores, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, generators, sensors, and/or logic. It will be appreciated that such systems, components, generators, sensors, and/or logic can be comprised of hardware items (such as processors and associated memory, or other processing components, some of which are described below) that perform the functions associated with those systems, components, generators, sensors, and/or logic. In addition, the systems, components, generators, sensors, and/or logic can be comprised of software that is loaded into a memory and is subsequently executed by a processor or server, or other computing component, as described below. The systems, components, generators, and/or logic can also be comprised of different combinations of hardware, software, firmware, etc., some examples of which are described below. These are only some examples of different structures that can be used to form the systems, components, generators, sensors, and/or logic described above. Other structures can be used as well.

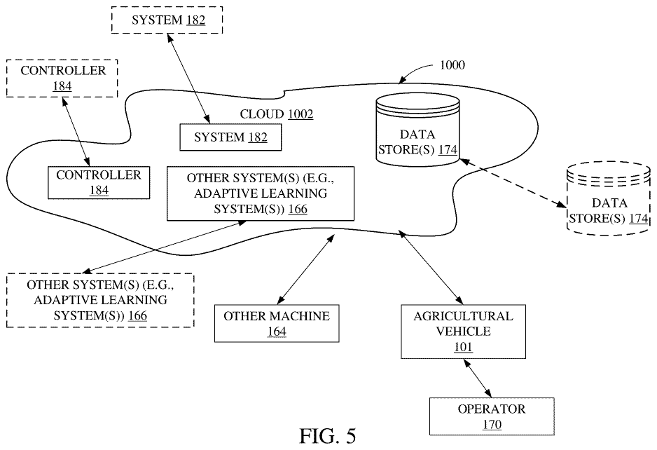

FIG. 5 is a block diagram of agricultural system 100, shown in FIG. 1, except that harvester 101 communicates with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network, and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 5, some items are similar to those shown in previous FIGS. and they are similarly numbered. FIG. 5 specifically shows that severed crop material quantity generation system 182, capacity controller 184, data store 174, and/or other systems 166 can be located at a remote server location 502. Therefore, harvester 101 accesses those systems through remote server location 502.

FIG. 5 also depicts another example of a remote server architecture. FIG. 5 shows that it is also contemplated that some elements of previous FIGS are disposed at remote server location 502 while others are not. By way of example, data store 174, capacity controller 184, severed crop material quantity generation system 182, and/or other systems 166 can be disposed at a location separate from location 502 and accessed through the remote server at location 502. Regardless of where the items are located, they can be accessed directly by harvester 101, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

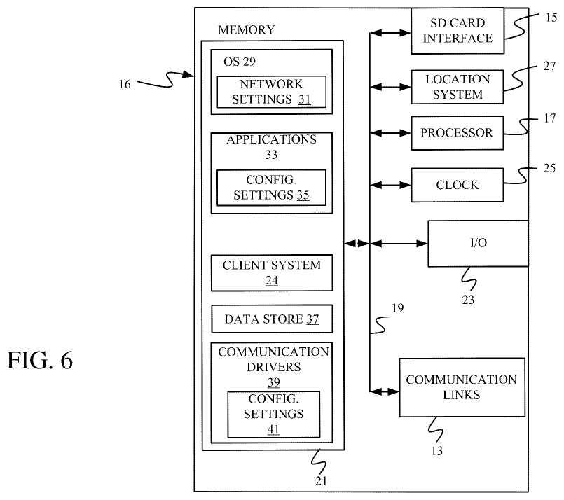

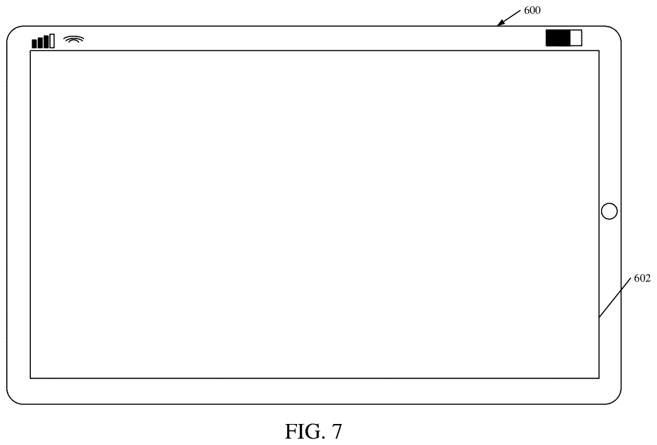

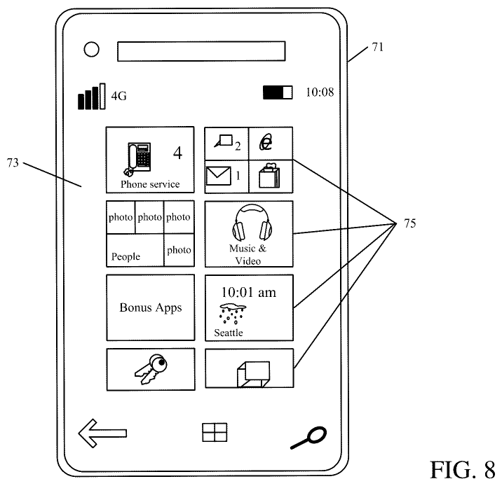

FIG. 6 is a simplified block diagram of one illustrative example of a handheld or mobile computing device that can be used as a user's or client's handheld device 16, in which the present system (or parts of it) can be deployed. For instance, a mobile device can be deployed in operator compartment 119 of harvester 101 for use in generating, processing, or displaying the severed crop volume. FIGS. 7-8 are examples of handheld or mobile devices.

FIG. 6 provides a general block diagram of the components of a client device 16 that can run some components shown in previous FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 7 shows one example in which device 16 is a tablet computer 600. In FIG. 7, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

FIG. 8 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

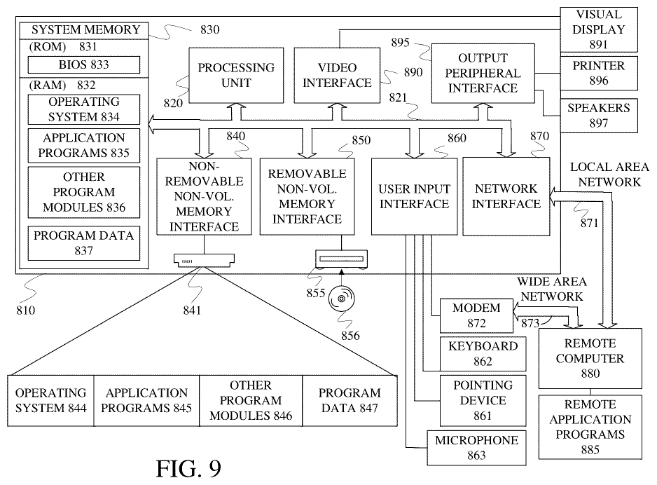

FIG. 9 is one example of a computing environment in which elements of previous FIGS., or parts of it, (for example) can be deployed. With reference to FIG. 9, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network—CAN, local area network—LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 9 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
obtaining characteristic data on an agricultural harvester indicative of one or more characteristics;
generating, based on the characteristic data, a severed crop material quantity signal indicative of a severed crop material quantity corresponding to a header on the agricultural harvester;
assessing the severed crop material quantity to generate an assessment output; and
controlling the agricultural harvester at a worksite based on the assessment output.

2. The computer implemented method of claim 1, wherein obtaining the characteristic data comprises:
obtaining sensor data, from one or more sensors on the agricultural harvester, indicative of one or more characteristics.

3. The computer implemented method of claim 1, wherein obtaining the characteristic data comprises:
obtaining maps of the worksite, the maps indicative of the one or more characteristics.

4. The computer implemented method of claim 1, wherein the one or more characteristics comprise one or more of:
one or more plant characteristics; or
one or more non-plant characteristics.

5. The computer implemented method of claim 1, wherein assessing the severed crop material quantity to generate the assessment output comprises:
obtaining a reference;
comparing the severed crop material quantity to the reference; and
generating, as the assessment output, a comparison result based on the comparison of the severed crop material quantity to the reference.

6. The computer implemented method of claim 5, wherein obtaining the reference comprises obtaining one of: a severed crop material quantity capacity corresponding to the header or a severed crop material quantity target corresponding to the header.

7. The computer implemented method of claim 5, wherein obtaining the reference comprises obtaining a previous severed crop material quantity identified previously during operation of the agricultural harvester at the worksite.

8. The computer implemented method of claim 1, wherein generating the severed crop material quantity signal comprises:
providing the characteristic data as model input to a quantity machine learning model to generate the severed crop material quantity signal indicative of the severed crop material quantity.

9. The computer implemented method of claim 8 and further comprising:
obtaining data;
calculating a severed crop material quantity based on the data; and
running adaptive learning to generate an adapted quantity machine learning model based on the severed crop material quantity and the calculated crop severed crop material quantity.

10. The computer implemented method of claim 9, wherein obtaining the data comprises obtaining one or more of:
threshing component drive sensor data; or
mass flow sensor data.

11. The computer implemented method of claim 1, wherein generating the severed crop material quantity signal comprises one of:
running a quantity algorithm based on the characteristic data; or
accessing a quantity table based on the characteristic data.

12. The computer implemented method of claim 1 wherein controlling the agricultural harvester comprises:
controlling one or more controllable subsystems of the agricultural harvester or the header based on the assessment output.

13. The computer implemented method of claim 1 wherein controlling the agricultural harvester comprises:
controlling an operator interface system of the agricultural harvester based on the comparison result.

14. A control system for an agricultural harvester, the control system comprising:
one or more processors; and
memory storing instructions, executable by the one or more processors, that, when executed by the one or more processors, configure the one or more processors to:
obtain characteristic data indicative of one or more characteristics;
generate, based on the characteristic data, a severed crop material quantity output indicative of a severed crop material quantity corresponding to a header on the agricultural harvester;
assess the severed crop material quantity to generate an assessment output; and
control the agricultural harvester at a worksite based on the assessment output.

15. The control system of claim 14, wherein the characteristic data comprises includes at least one or more of:
sensor data, from one or more sensors on the agricultural harvester, indicative of a first characteristic of the one or more characteristics; or
a map of the worksite indicative of a second characteristic of the one or more characteristics.

16. The control system of claim 14, wherein the instructions, when executed by the one or more processors, configure the one or more processors to:
obtain a reference;
compare the severed crop material quantity to the reference; and
generate, as the assessment output, a comparison result based on the comparison of the severed crop material quantity to the reference.

17. The control system of claim 14, wherein the instructions, when executed by the one or more processors, configure the one or more processors to:
provide the characteristic data as model input to a quantity machine learning model to generate the severed crop material quantity output.

18. The control system of claim 14, wherein the instructions, when executed by the one or more processors, configure the one or more processors to generate the severed crop material quantity output by one of:
running a quantity algorithm based on the characteristic data; or
interacting with a quantity table based on the characteristic data.

19. The control system of claim 14, wherein the instructions, when executed by the one or more processors, configure the one or more processors to control the agricultural harvester at the worksite based on the assessment output by controlling one or more controllable subsystems of the agricultural harvester at the worksite based on the assessment output.

20. An agricultural harvester comprising:
a header configured to sever crop at a worksite to generate severed crop material;
one or more processors; and
memory storing instructions, executable by the one or more processors, that, when executed by the one or more processors, configure the one or more processors to:
obtain characteristic data indicative of one or more characteristics;
generate, based on the characteristic data, a severed crop material quantity output indicative of a severed crop material quantity corresponding to the header;
assess the severed crop material quantity to generate an assessment output; and
control the agricultural harvester at the worksite based on the assessment output.
